(19) United States
(12) Patent Application Publication
(10) Pub. No.: US 2006/0266364 A1
(43) Pub. Date: Nov. 30, 2006

(54) Fluid barrier face mask

(75) Inventor: Crest Turdjian, Los Angeles, CA (US)

Correspondence Address: Charles H. Schwartz, 10111 W. Jefferson Blvd., Culver City, CA, 90232, US

(73) Assignee: Moldex Metric, Inc.

(21) Appl. No.: 11/137,215

(22) Filed: May 24, 2005

(51) Int. Cl. A62B 23/02; A62B 18/02; A62B 18/08

(52) U.S. Cl. 128/206.19; 128/205.25; 128/205.29; 128/206.12; 128/206.21; 128/206.27; 128/206.28

(57) ABSTRACT

A face mask to be worn upon the face of a wearer and for providing filtering of particular impurities in the air, including at least one pre-bonded composite layer formed by a combination of flexible plastic material and a non-woven fabric and with the pre-bonded composite layer molded generally to conform to the contours of the face of the wearer and forming a flexible support carrier for filter material and with the one pre-bonded composite layer providing a plurality of perforations through the one pre-bonded composite layer for allowing the free passage of air through the one pre-bonded composite layer while preventing the passage of liquid from a position outside the face mask, and a separate layer of filter material supported by the one pre-bonded composite layer and with the filter material filtering out the particular impurities in the air.

### BACKGROUND OF THE INVENTION

Health care professionals often wear a face mask as standard procedure for many activities. Physicians, nurses, lab technicians, dentists all may use a face mask in appropriate circumstances.

Most filter face masks used by health care professionals filter out germs and particles, but are not a barrier to liquids. During various medical procedures, body fluids such as blood, urine and saliva may be splashed, sprayed or thrown into the face of the health care professional. The force of the splashing may produce a penetration of many currently available protective masks with a portion of the body fluid. It is therefore desirable that the face mask be a barrier liquids so these body fluids cannot contact the eyes, nose and mouth of a user of the face mask.

### SUMMARY OF THE INVENTION

The present invention relates to face masks and in particular to fluid barrier face masks formed from a plurality of layers and with the individual layers serving different functions. In the face mask of the present invention, at least one pre-bonded composite layer is formed of a combination of openwork flexible plastic material and a non-woven fabric and the pre-bonded composite layer serves as a support layer for carrying at least another layer of filter material. In a particular embodiment of the invention, a pair of layers of openwork flexible plastic material, of which at least one is a pre-bonded composite layer, form the support for the filter layer, and with the layer of filter material sandwiched in between the layers of openwork plastic material.

With the fluid barrier face mask of the present invention, the use of the openwork plastic material provides for a flexible yet shape-retaining carrier support for the filter material. Moreover, since the plastic material has an openwork configuration which provides for a plurality of perforations, the openwork plastic material allows for the generally unrestricted passage of a high volume of air. The pre-bonding of the non-woven fabric to the openwork plastic additionally provides for a fluid barrier to the passage of fluids from a position outside the face mask. Since the pre-bonded composite layer allows for the passage of a high volume of air while at the same time is resistant to fluid passage, the face mask of the present invention is comfortable to wear since the breathing of the wearer is not unduly restricted but the passage of fluid from an external position is restricted.

The layer of filter material may be of any of the general types of filter material commonly used with face masks for providing for the filtering of particular impurities in the air. With the fluid barrier face mask of the present invention, the filter material may be relatively thick and yet still be properly supported by the carrier layers of openwork plastic. In addition, the filter material currently used may not be shape retaining or self supporting, so it is necessary to use some sort of carrier means to provide for the support of the filter material.

In the face mask of the present invention, the openwork plastic material may be formed from a plastic sheet which has a pattern of openings or may be formed from a sheet of woven material or may be formed from a sheet of mesh material. In particular, the openwork plastic layer may be formed from various plastic materials such as vinyl, polyethylene, synthetic or real rubber or other materials or combinations of materials. As an example, the openwork plastic layer has been formed from ethyl vinyl acetate.

The filter material may be formed from various types of filter materials, such as non-woven polyester fiber, electrostatically charged polypropylene, activated charcoal, various types of natural fibers and other filter materials currently used. Many of the filter materials currently used to provide the filter portion of face masks cannot stand a high degree of heat since the heat may reduce or eliminate the filtering properties of the material. With the present invention, the face mask may be formed using a method which does not subject the filter material to a high degree of heat, so that the filtering properties of the filter material are not substantially affected.

In a first particular embodiment of the present invention, the face mask is formed from multiple layers of material and specifically includes at least one pre-bonded composite layer formed by a combination of flexible plastic material and a non-woven fabric to support a layer of filter material. A second layer of flexible plastic material may be used to support the layer of filter in between the openwork plastic layers. The inner layer of a soft material pre-bonded to the flexible plastic material serves as a layer positioned against the face of the wearer of the mask. This soft material provides additional comfort to the wearer of the face mask and additionally, the pre-bonded combination of the flexible plastic material and the non-woven fabric provide a barrier to the passage of fluids from a position external to the face mask.

The fluid barrier face mask of the present invention may also include various additional means to provide a seal along the peripheral edge of the face mask. For example, a separate gasket in whole or part may be attached around the peripheral edge to seal the peripheral edge of the face mask and also to seal the edge of the face mask against the face of the wearer of the mask. Other means for sealing the peripheral edge of the face mask include cutting with a hot blade the layers of the face mask to the desired outer configuration so as to melt the openwork plastic layers at the peripheral edge and thereby provide for a sealing of the peripheral edge. This may be seen in more detail in U.S. Pat. No. 4,850,347 assigned to the same assignee as the instant application and the disclosure of this patent is incorporated by reference.

The fluid barrier face mask may also include an outer layer fabric to serve as an initial barrier to the passage of fluids from an external position. This outer layer may also be a non-woven fabric. The outer layer need not be pre-bonded to the adjacent layer of flexible plastic material but it can be pre-bonded to improve the visual appearance of the face mask and improve the fluid barrier.

The present invention therefore is directed to a face mask to be worn upon the face of a wearer and for providing filtering of particular impurities in the air, The face mask includes at least one pre-bonded composite layer formed by a combination of flexible plastic material and a non-woven fabric. The pre-bonded composite layer is molded generally to conform to the contours of the face of the wearer and forms a flexible support carrier for filter material. The one pre-bonded composite layer provides a plurality of perforations through the one pre-bonded composite layer for allowing the free passage of air through the one pre-bonded composite layer while preventing the passage of liquid from a position outside the face mask. A separate layer of filter material is supported by the one pre-bonded composite layer and with the filter material filtering out the particular impurities in the air.

A clearer understanding of the present invention will be had with reference to the following description and drawings wherein:

FIG. 1 is a perspective view of a first embodiment of a fluid barrier face mask constructed in accordance with the teachings of the present invention;

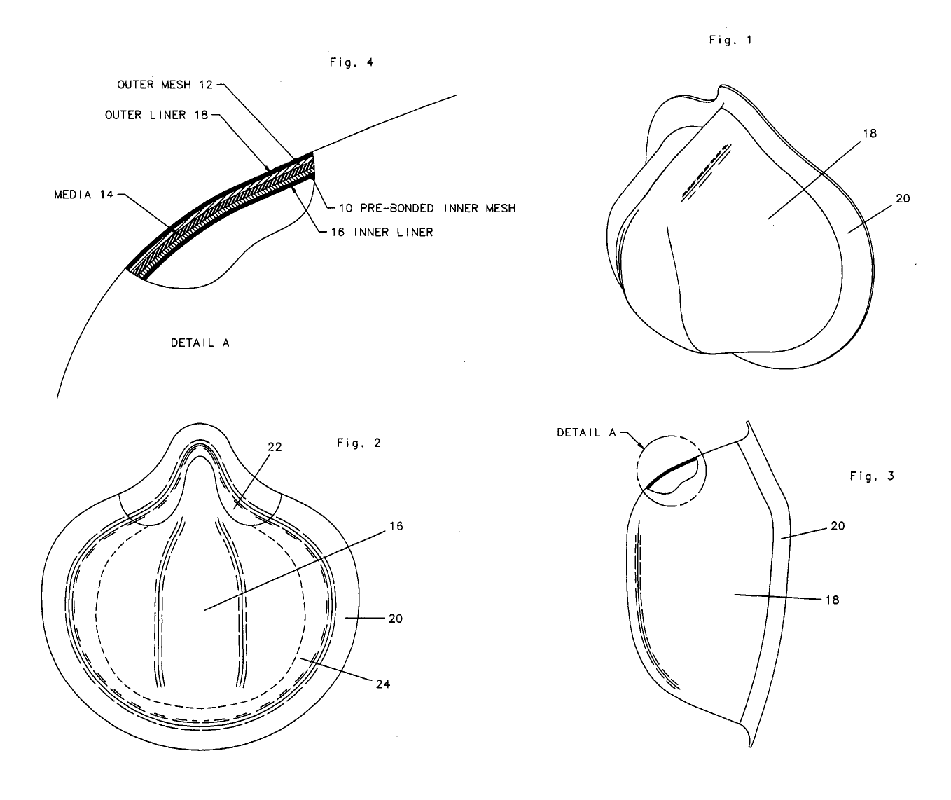

FIG. 2 is a rear or inside view of the first embodiment of the invention;

FIG. 3 is a side view of the first embodiment of the invention and including a cross-sectional portion labeled Detail A;

FIG. 4 is a blown up view of the cross-sectional portion labeled Detail A;

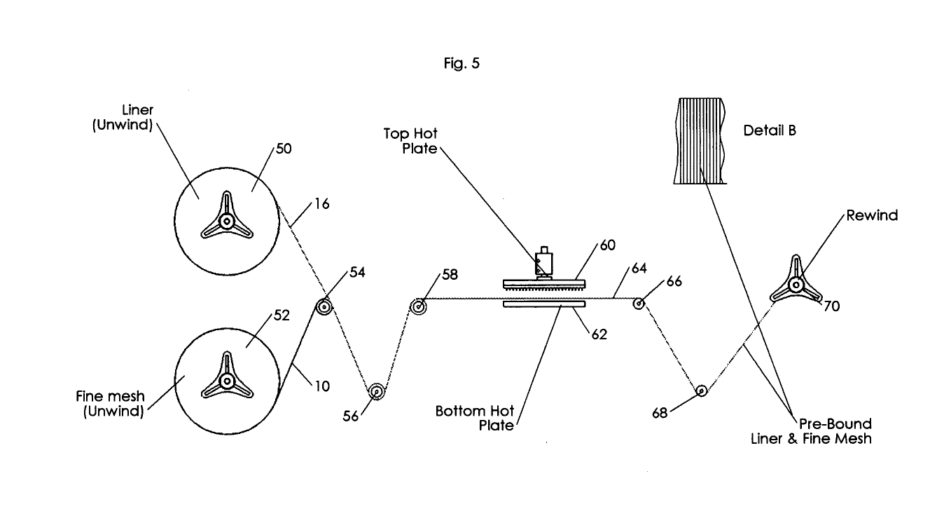

FIG. 5 illustrates a method for forming the pre-bonded layer of the present invention, and

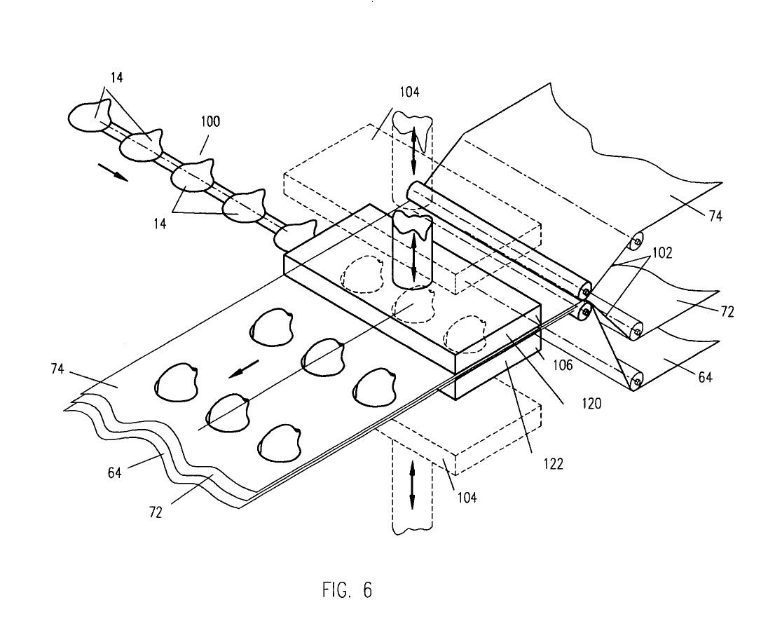

FIG. 6 illustrates a method for forming the face mask of the present invention.

FIGS. 1 through 4 illustrate a first embodiment of the fluid barrier face mask of the present invention, which face mask includes multiple layers of material. Specifically, as shown in FIG. 4 a pair of openwork flexible plastic layers 10 and 12 sandwich a layer of filter media 14. A layer of a soft fabric 16 is positioned on the inside surface of the face mask and is pre-bonded to the flexible plastic layer 10 to form a composite layer. The soft fabric 16 provides for additional comfort for the wearer of the face mask and the pre-bonding of the soft fabric 16 to the openwork flexible plastic layer 10 provides a combination composite layer that is a fluid barrier to the passage of fluids from a position external to the face mask.

An outer layer 18, which may also be a soft layer of a similar material to the soft layer 16, may overlay the face mask and provide an initial barrier to fluids. The layer 18 may also be pre-bonded to the openwork flexible plastic layer 12 to enhance the fluid barrier and to improve the cosmetic appearance of the face mask. An elastic band (not shown) may be attached by staples and used to support the face mask in position against the face.

The openwork plastic layers 10 and 12 provide for support layers to carry the filter material 14. In particular, the openwork plastic layers may be formed from sheets which have a plurality of openings therethrough to permit the free passage of air. For example, the openwork plastic layers may be formed from a perforated plastic material, a woven plastic material, a mesh plastic material, etc. In general, the plastic material is of the type that can be molded to a desired contour configuration and will retain that configuration so as to support the filter material, yet at the same time being flexible enough to allow for the face mask to conform to different facial contours of individual wearers of the mask. Specifically, the openwork plastic layers may be composed of various types or combinations of plastic materials such as vinyls, polyethylenes, synthetic or real rubber, etc., which allow for moldability to form the desired configuration yet with flexibility to allow for the shaped mask to fit the face of individual wearers.

The filter layer 14 may be formed from any of the known types of filter materials such as non-woven polyester fiber material, electrostatically charged polypropylene, activated charcoal, various natural fibers such as merino wool, or other types of materials used for filtering.

In the first embodiment of the face mask shown in FIGS. 1 through 4, an inner layer of a soft fabric is provided for comfort. This layer may be formed of material such as non-woven spun bond plastic material such as polypropylene that will adhere to the inner layer of openwork plastic during a pre-bonding step in the manufacturing process. As shown in FIGS. 1 through 3, an edge portion 20 is formed during the molding of the mask as shown in FIG. 5 and the edge portion 20 extends around the periphery of the mask. As indicated above, an elastic band (not shown) may be attached to the edge portion 20 using staples or any other known means.

The face mask of the present invention may also include a sealing flange extending around all or a portion of the inside of the edge 20 for sealing the peripheral edge portion of the face mask to the face of the wearer. This additional sealing provides for a closer fitting of the mask to the face of the wearer. As shown in full line portion in FIG. 2, a sealing flange 22 may extend just in the nose and cheek area of the face of the wearer. Alternatively, as shown in the combined full line and dotted line portions in FIG. 2, a flange 24 may extend completely around the entire edge 20 of the mask.

FIGS. 5 and 6 illustrates a method of making the face mask of the present invention and specifically a method of molding the face mask to the desired contour configuration. In the pre-bonding method as shown in FIG. 5, The inner liner material 16 and the openwork plastic or mesh 10 are unwound from rolls of material 50 and 52 to merge and be guided by rollers 54, 56 and 58 and between top and bottom hot plates 60 and 62. The hot plates 60 and 62 heat the materials 10 and 16 sufficiently to pre-bond the materials together to form a single composite layer 64. The specific temperature would be dependent on the particular materials used but the resultant layer has the individual characteristics of each material on the outer surfaces of the composite layer but with the individual layers adhearing to each other at the interface between the individual materials. The composite layer 64 is guided by rollers 66 and 68 to a takeup roller 70. The pre-bound liner 16 and fine mesh 10 forming the composite layer 64 on the takeup roll 70 is shown by detail B in FIG. 5

As shown in FIG. 6, filter material 14 may be provided in sheets or may be precut, as shown by step 100. The precut filter material 14 is to be inserted between top and bottom sheets of plastic openwork material the bottom one of which is the pre-bonded composite layer 64. A top sheet of plastic openwork material 72 provides the outer mesh layer 12 of the finished mask. This is shown in step 104. The top and bottom sheets of plastic material 72 and 64 are to be inserted between male and female molds 120 and 122. The precut filter material 110 is also to be inserted in the proper position between the male and female molds 120 and 122 and between the top and bottom sheets 72 and 64. Additionally, soft fabric 74 may be inserted between the male mold and the top sheet 72 of openwork plastic to form the outer liner 18 of the mask. It is to be appreciated that the sheets 72 and 74 may also be pre-bonded if desired.

In the next step 106, the molds 120 and 122 are brought together to capture the top and bottom sheets of plastic material 72 and 64, the precut filter material 14 and the fabric 74, so as to provide for molding of individual face masks. All of the desired embodiments of the face mask described above may be made by this method as long as at least one pre-bonded composite layer of the openwork flexible plastic material is used to carry and support the filter material so as to allow for a high volume of air to pass through the opening in the openwork plastic material while at the same time providing a barrier to the passage of fluids.

As a final step, the individual face masks may be cut from the large sheets and the edges may be sealed either as shown in FIGS. 1-3.

The present invention, therefore, provides for an improved face mask providing for both desirable filter characteristics yet allowing the masks to conform to the configuration of the face of the wearer and also allowing for a relatively high volume of air to pass through the mask to the wearer of the mask while at the same time providing a barrier to the passage of fluids.

Although the invention has been described with reference to particular embodiments, it is to be appreciated that various adaptations and modifications may be made, and the invention is only to be limited by the appended claims.

I claim:

1. A fluid barrier face mask to be worn upon the face of a wearer and for providing filtering including the following,
at least one layer of pre-bonded composite material formed by the combination of at least one layer of flexible plastic material and a layer of non-woven plastic fabric and with the flexible plastic material formed from openwork flexible plastic material for providing a plurality of perforations for allowing for the free passage of air through the openwork plastic while at the same time the at least one layer of pre-bonded composite material provides a barrier to the passage of fluids, and
a layer of filter material for filtering impurities in the air and with the at least one layer of pre-bonded composite material and the layer of filter material molded together to form the face mask to the desired configuration to provide for filtering of impurities in the air while at the same time providing a barrier to the passage of fluids.

2. The fluid barrier face mask of claim 1 wherein the layer of non-woven plastic fabric is a spun bond polypropylene.

3. The fluid barrier face mask of claim 1 including an additional layer of openwork flexible plastic material and wherein the layer of filter material is sandwiched between the one layer of pre-bonded composite material and the additional layer of openwork flexible plastic when the layers are molded together to form the face mask to the desired configuration.

4. The fluid barrier face mask of claim 3 additionally including an additional outer layer of soft fabric and with the additional layer of soft fabric located outside the additional layer of openwork flexible plastic material when the layers are molded together to form the face mask to the desired configuration.

5. The fluid barrier face mask of claim 3 additionally including a edge portion formed during the molding of the face mask and extending around the peripheral edge of the layers of openwork flexible plastic.

6. The fluid barrier face mask of claim 1 additionally including an additional outer layer of soft fabric and with the additional layer of soft fabric located outside the filter material when the layers are molded together to form the face mask to the desired configuration.

7. The fluid barrier face mask of claim 6 wherein the additional outer layer of soft fabric is formed from a non-woven spun bond polypropylene.

8. The fluid barrier face mask of claim 1 additionally including an edge portion formed during the molding of the face mask and extending around the peripheral edge of the one layer of pre-bonded composite material.

9. A method of making a fluid barrier face mask to be worn upon the face of a wearer and for providing filtering including the following steps,
providing at least one layer of flexible plastic material formed from openwork flexible plastic material for providing a plurality of perforations for allowing for the free passage of air through the openwork plastic,
providing a layer of soft non-woven plastic fabric,
pre-bonding the at least one layer of flexible plastic material and the layer of soft non-woven plastic fabric to form a composite layer with the flexible plastic material providing a plurality of perforations for allowing for the free passage of air through the openwork plastic while at the same time the pre-bonded composite material provides a barrier to the passage of fluids,
providing a layer of filter material for filtering impurities in the air,
providing male and female molding members having a mold configuration conforming generally to the contours of the face of the wearer,
moving the composite layer and the layer of filter material between the male and female molding members, and
pressing the male and female molding members together to form the face mask to the desired configuration by molding the at least one composite layer including the openwork flexible plastic material to form a support layer to carry the layer of filter material to form the face mask which allows for the free passage of air through the openwork plastic while at the same time the pre-bonded composite material provides a barrier to the passage of fluids.

10. The method of claim 9 wherein an additional layer of openwork flexible plastic material is provided and wherein the layer of filter material is sandwiched between the additional layer of openwork flexible plastic and the pre-bonded composite layer when the male and female molding members are pressed together.

11. The method of claim 10 additionally including the step of providing a layer of soft fabric and moving the layer of soft fabric between the molding members at a position intermediate the female molding member and the additional layer of open work flexible plastic material for covering the outer surface of the face mask.

12. The method of claim 10 additionally including the step of forming a edge portion during the molding of the face mask and with the edge portion extending around the peripheral edge of the layers of openwork flexible plastic.

13. The method of claim 10 additionally including the step of precutting the layer of filter material to a particular configuration before the filter material is sandwiched between and the layers of openwork flexible.

14. The method of claim 9 additionally including the step of providing a layer of soft fabric and moving the layer of soft fabric between the molding members at a position intermediate the female molding member and the layer of filter material for covering the outer surface of the face mask.

15. The method of claim 9 additionally including the step of forming a edge portion during the molding of the face mask and with the edge portion extending around the peripheral edge of the composite layer of material.

16. The method of claim 9 additionally including the step of precutting the layer of filter material to a particular configuration before the filter material is positioned between the male and female molding members.
